(19) United States
(12) Patent Application Publication
(10) Pub. No.: US 2019/0017504 A1
(43) Pub. Date: Jan. 17, 2019

(54) SCREW PUMP

(71) Applicants: DENSO CORPORATION, Kariya-city, Aichi-pref. (JP); SOKEN, INC., Nishio-city, Aichi-pref. (JP)

(72) Inventors: Masashi INOUE, Nishio-city (JP); Yasuhiro TAKEUCHI, Nishio-city, Aichi-pref. (JP); Haruo KAMIYA, Nishio-city (JP); Yusuke HONGO, Kariya-city (JP); Masahiro OKAJIMA, Kariya-city (JP)

(21) Appl. No.: 16/069,607

(22) PCT Filed: Jan. 13, 2017
(86) PCT No.: PCT/JP2017/000932

§ 371 Date: Jul. 12, 2018

(30) Foreign Application Priority Data
Feb. 4, 2016 (JP) 2016-19932

(51) Int. Cl. F04C 15/00; F02M 37/08; F04C 2/16

(52) U.S. Cl. CPC F04C 15/00; F02M 37/08; F04C 2/16; F04C 2240/40; F04C 2240/20; F04C 2240/30; F04C 2240/50

(57) ABSTRACT

A screw pump includes a male screw, a female screw, a motor, a journal, a bearing member, and a case. The motor includes an output shaft, which transmits a torque to the male screw, and the motor is operable to drive the male screw to rotate the same through the output shaft. The journal is rotatably placed between the output shaft of the motor and the male screw. The bearing member rotatably supports the journal. The case includes a screw receiving hole that receives the male screw and the female screw. The journal and the male screw are coaxially and non-detachably integrated together. The output shaft and the journal are fitted together by clearance fit that enables transmission of the torque between the output shaft and the journal.

### CROSS REFERENCE TO RELATED APPLICATION

This application is based on and incorporates herein by reference Japanese Patent Application No. 2016-19932 filed on Feb. 4, 2016.

### Technical Field

The present disclosure relates to a screw pump that pumps fluid by rotating screws.

### Background Art

Previously, there is known a fluid pump that pumps fluid by rotating, for example, an impeller. For example, a water pump, which is disclosed in the patent literature 1, pumps cooling water by rotating an impeller, which is installed to a rotor of an electric motor, through rotation of the electric motor. Two opposite end portions of the rotor are rotatably supported by a case through dynamic pressure bearings, respectively.

At the time of pumping the cooling water with the water pump of the patent literature 1, the pressure of the cooling water is applied to the impeller, so that the rotational axis of the rotor, which is coupled with the impeller, may be decentered. This will result in generation a gap between the impeller and the case in the pump unit. The generation of the gap between the impeller and the case in the pump unit will possibly cause generation of a backflow of the cooling water and contact of the impeller against the case, resulting in an increase in a sliding loss.

The above disadvantage occurs not only in the impeller pump but also in a screw pump that includes a male screw and a female screw, which are meshed with each other and are rotated together to pump fluid. In the screw pump, a journal shaft is placed between an output shaft of a drive device and the male screw that is coupled with the output shaft. A tip of the male screw, which is opposite from the output shaft, is supported in point contact by a receiving plate installed to a lower cover.

Normally, the male screw and the journal are formed by separate members, respectively, and are rotated together when a rotational drive force of the drive device is transmitted to the journal and the male screw. However, in a case where the journal and the male screw are integrated together by clearance fit through use of a key, rattling of the male screw may possibly occur at the gap between the journal and the male screw to cause decentering of axis of the male screw relative to the case. When the axis of the male screw is decentered relative to the case, it may possibly disadvantageously cause leakage of the fluid in the inside of the pump unit and an increase in the sliding loss and wearing like in the case of the impeller pump.

### CITATION LIST

### Patent Literature

PATENT LITERATURE 1: JP2003-328986A

### SUMMARY OF INVENTION

The present disclosure addresses the above disadvantages, and it is an objective of the present disclosure to provide a screw pump that improves a reliability of sliding portions thereof by reducing a sliding loss and wearing, which are generated by deviation between a central axis of a screw and a central axis of a journal.

The screw pump of the present disclosure is a screw pump that pumps fluid from a suction inlet at a low pressure side to a discharge outlet at a high pressure side when a driving-side screw, which is one of a male screw or a female screw, and at least one driven-side screw, which is another one of the male screw or the female screw, are rotated while the driving-side screw and the at least one driven-side screw are meshed with each other.

The screw pump includes the driving-side screw, the at least one driven-side screw, a drive device, a journal portion, a bearing portion and a case. The drive device includes an output shaft that transmits a torque to the driving-side screw. The drive device is operable to rotate the driving-side screw through the output shaft.

The journal portion is rotatably placed between the output shaft of the drive device and the driving-side screw. The bearing portion rotatably supports the journal portion. The case includes a screw receiving hole, which receives the driving-side screw and the at least one driven-side screw.

The journal portion and the driving-side screw are coaxially and non-detachably integrated together. The output shaft and the journal portion are fitted together by clearance fit that enables transmission of the torque between the output shaft and the journal portion. Here, the term “coaxial” is not necessarily limited to “coaxial” in a strict sense. That is, as long as the axes of two members are in a range that is normally determined as “coaxial” in light of the technical common sense in the technical field, the axes of these members should be interpreted as “coaxial.”

With the above construction, the journal portion and the driving-side screw are coaxially and non-detachably integrated together. Thereby, at the time of pumping the fluid, the axis of the journal portion and the axis of the driving-side screw do not deviate relative to each other. For example, in a case where the journal portion and the driving-side screw are integrated together by the clearance fit, there is a possibility of that the central axis of the journal and the central axis of the male screw deviate from each other due to influences of rattling at the clearance, and thereby the screw center may possibly deviate in the screw receiving hole.

With respect to this point, according to the construction of the present disclosure, the central axis of the journal portion and the central axis of the driving-side screw do not deviate relative to each other. Thus, the sliding loss and the wearing, which are caused by, for example, decentering of the screw relative to the screw hole in the previously proposed screw pump, are reduced. In this way, the reliability of the sliding portions can be improved.

### BRIEF DESCRIPTION OF DRAWINGS

The present disclosure, together with additional objectives, features and advantages thereof, will be best understood from the following description, the appended claims and the accompanying drawings.

FIG. 1 is an overall view of a structure of a fuel supply system, to which a screw pump of FIG. 2 is applied.

FIG. 2 is a schematic cross-sectional view of the screw pump according to a first embodiment of the present disclosure.

FIG. 3 is a cross-sectional view taken along line III-III in FIG. 2 at a pumping time.

FIG. 4 is an enlarged view of an area IV shown in FIG. 3.

FIG. 5 is a radial cross-sectional view of a case of a screw pump according to a second embodiment of the present disclosure.

FIG. 6 is a schematic cross-sectional view of a screw pump according to a third embodiment of the present disclosure.

FIG. 7 is a schematic partial cross-sectional view of a screw pump according to a fourth embodiment of the present disclosure.

FIG. 8 is an enlarged view of an area VIII shown in FIG. 7.

FIG. 9 is a schematic partial cross-sectional view of a screw pump according to a fifth embodiment of the present disclosure.

FIG. 10 is an enlarged view of an area X shown in FIG. 9.

FIG. 11 is a schematic cross-sectional view of a screw pump according to a sixth embodiment of the present disclosure.

### DESCRIPTION OF EMBODIMENTS

Hereinafter, a screw pump of each of various embodiments will be described with reference to the drawings. In the following embodiments, substantially identical portions will be indicated by the same reference signs and will not be redundantly described for the sake of simplicity.

### First Embodiment

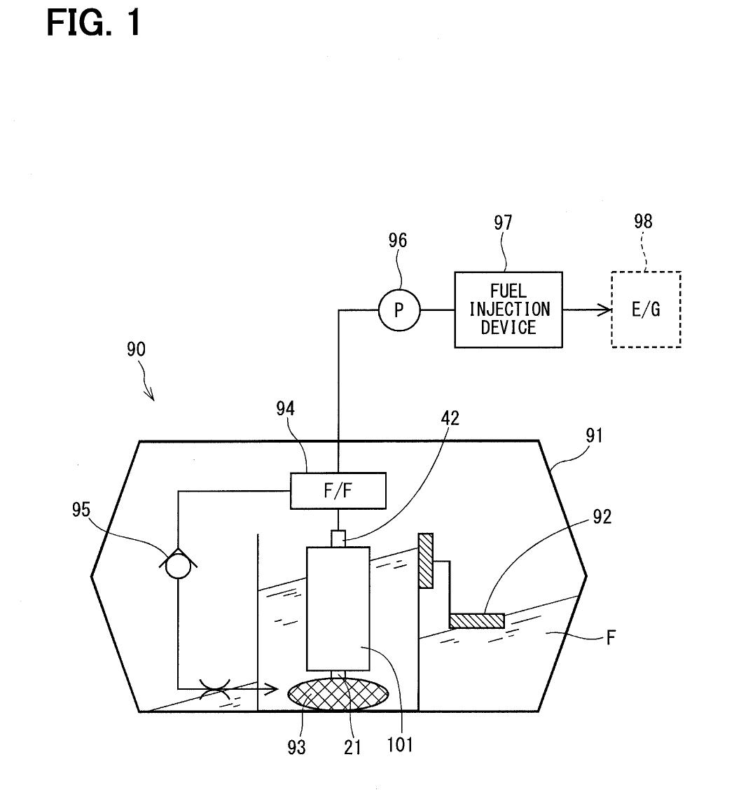

First of all, an overall structure of a fuel supply system, to which a screw pump of the respective embodiments of the present disclosure is applied, and a schematic structure of the screw pump will be described with reference to FIGS. 1 to 4.

As shown in FIG. 1, the fuel supply system 90 includes: a liquid level sensor 92, which is installed in an inside of a fuel tank 91; a suction filter 93; a screw pump 101; a fuel filter (abbreviated as F/F in the drawing) 94; a pressure regulator 95; a high pressure pump 96; and a fuel injection device 97 while the high pressure pump 96 and the fuel injection device 97 are placed near an engine (abbreviated as E/G in the drawing) 98. The fuel supply system 90 supplies fuel F, such as gasoline, from the fuel tank 91 to the engine 98.

The screw pump 101 suctions the fuel F of the fuel tank 91 through a suction inlet 11 after filtration of the fuel F through the suction filter 93. Thereafter, the screw pump 101 pressurizes the suctioned fuel F and discharges the pressurized fuel F through a discharge outlet 32. The discharged fuel F is delivered to the high pressure pump 96 through the fuel filter 94. An excess amount of the fuel F, which corresponds to an excess pressure of the fuel F, is returned into the fuel tank 91 through the pressure regulator 95 that is installed in a branch passage located after the fuel filter 94, so that a discharge pressure of the fuel F is adjusted.

The high pressure pump 96 further pressurizes the fuel, which is delivered from the screw pump 101, and the high pressure pump 96 delivers the pressurized fuel to the fuel injection device 97. The fuel injection device 97 includes a plurality of fuel injection valves (injectors) and a control device while the control device controls fuel injection of the respective fuel injection valves, so that the fuel injection device 97 injects the high pressure fuel into each corresponding cylinder and/or an intake passage of the engine 98. As discussed above, the screw pump 101 of the present embodiment is installed in the inside of the fuel tank 91 in the fuel supply system 90 and performs the function that is previously performed by, for example, the impeller fuel pump.

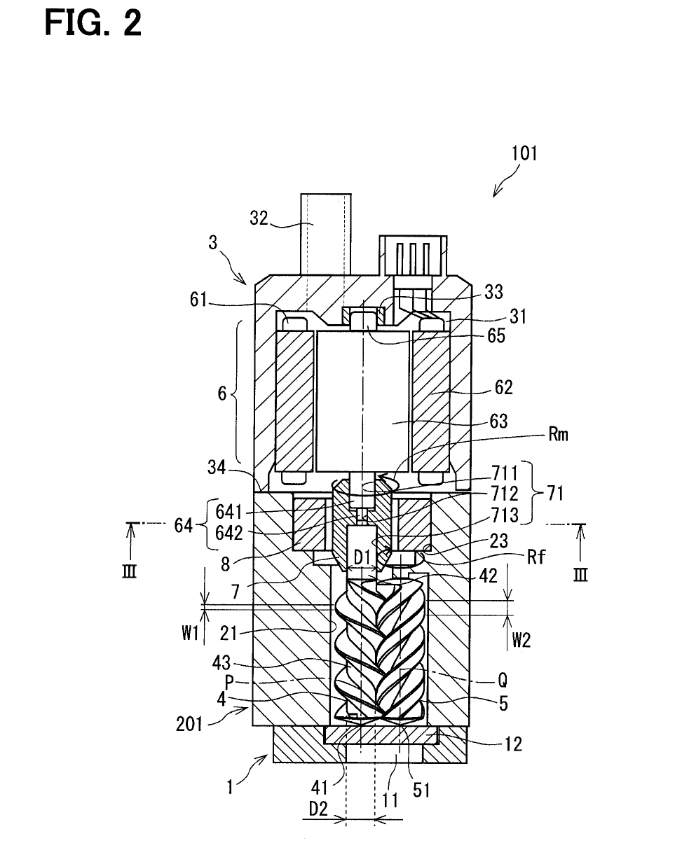

As shown in FIG. 2, the screw pump 101 includes: a lower cover 1; a receiving plate 12; a case 201; an upper cover 3; a male screw 4; a female screw 5; an electric motor 6, which serves as a drive device; a journal 7; and a bearing member 8. In the present embodiment, the male screw 4 corresponds to a driving-side screw that is coupled with an output shaft 64 of the motor 6, and the female screw 5, which is meshed with the male screw 4 and is driven by the male screw 4, corresponds to a driven-side screw. The journal 7 serves as an example of a journal portion of the claims. The bearing member 8 serves as an example of a bearing portion of the claims.

In the present embodiment, the male screw 4 is rotated about a rotational axis P in a rotational direction Rm that is a counterclockwise direction in a view taken from the motor 6 side. In response to the rotation of the male screw 4, the female screw 5 is rotated about a rotational axis Q in a rotational direction Rf that is a clockwise direction in the view taken from the motor 6 side.

A width W1 of each of crests of the male screw 4 is smaller than a width of each of roots of the male screw 4. A width W2 of each of crests of the female screw 5 is generally equal to a width of each of roots of the female screw 5. Hereinafter, the width of each crest will be defined as a blade width. The blade width W1 of the male screw 4 is smaller than the blade width W2 of the female screw 5. The crests of the female screw 5 are meshed with the roots of the male screw 4. In the present embodiment, the male screw 4 is a double-threaded screw, and the female screw 5 is a triple-threaded screw. A material of the male screw and the female screw is, for example, an iron-based material, such as SUJ2 that is the high carbon chrome bearing steel.

When the male screw 4 and the female screw 5 are rotated in the meshed state where the male screw 4 and the female screw 5 are meshed with each other, the screw pump 101 pressurizes the low pressure fuel suctioned through the suction inlet 11 and discharges the pressurized fuel through the discharge outlet 32. Hereinafter, the lower side and the upper side of FIG. 1 will be respectively defined as the suction inlet 11 side and the discharge outlet 32 side that are used to refer one axial side and the other axial side of the screw pump 101. In view of the fuel pressure, the suction inlet 11 side corresponds to a low pressure side, and the discharge outlet 32 side corresponds to a high pressure side.

The suction inlet 11 opens at one end portion of the lower cover 1, and the receiving plate 12 is placed between the case 201 and the suction inlet 11. A suction passage (not shown), which communicates between the suction inlet 11 and a case hole 21, is formed through the receiving plate 12.

The receiving plate 12 is placed such that the receiving plate 12 is perpendicular to the rotational axes P, Q at a tip of the male screw 4 and a tip of the female screw 5. The receiving plate 12 rotatably supports both of a tip apex 41 of the male screw 4 and a tip apex 51 of the female screw 5. The tip apex 41 of the male screw 4 and the tip apex 51 of the female screw 5 are respectively configured in a form of a conical projection and thereby are respectively in point contact with a surface of the receiving plate 12.

The case 201 has a case hole 21, which extends through the case 201 in the axial direction and serves as a screw receiving hole that receives the male screw 4 and the female screw 5. A radial cross-section of a portion of the case hole 21, which receives the male screw 4, and a radial cross-section of another portion of the case hole 21, which receives the female screw 5, are joined together in a form of a gourd-shape.

A bearing receiving portion 23 is recessed at an end surface 34 of the case 201 located on the motor 6 side. Furthermore, a communication passage (not shown), which communicates between the case hole 21 and a discharge chamber 31 of the upper cover 3, is formed at a corresponding location that is different from the location of the bearing receiving portion 23.

The upper cover 3 has the discharge chamber 31, which receives the fuel delivered from the communication passage, and the discharge outlet 32, which discharges the fuel from the discharge chamber 31 to an outside of the upper cover 3. The motor 6 is placed in the inside of the upper cover 3.

The motor 6 includes a stator 62, around which a coil 61 is wound to generate a rotating magnetic field, and a rotor 63, which is rotated in response to the rotating magnetic field generated from the stator 62 that has a plurality of permanent magnets that form a plurality of N-poles and a plurality of S-poles arranged alternately in a circumferential direction. An end portion 65 of a shaft of the rotor 63, which is located on the discharge outlet 32 side, is rotatably supported by a shaft holding portion 33 of the upper cover 3. Furthermore, another end portion of the shaft of the rotor 63, which is located on the suction inlet 11 side, serves as an output shaft 64 and is coupled with the journal 7. A detailed configuration of the output shaft 64 will be described later at a description with respect to assembling of the journal 7.

The journal 7 is integrally rotatably placed between the output shaft 64 of the motor 6 and the male screw 4. The bearing member 8 is a cylindrical tubular member and is received in the bearing receiving portion 23 to rotatably support the journal 7. A material of the journal 7 is, for example, an iron-based material, such as SKH51 that is the high-speed tool steel. The material, which has the higher hardness in comparison to the material of the male screw 4, is used as the material of the journal 7.

Next, there will be described the assembling of the male screw 4 and the journal 7 and the assembling of the journal 7 and the output shaft 64, which are characteristic features of the present disclosure. A connecting shaft 42 is formed integrally with the male screw 4 in one piece at a tip of the male screw 4 located on the discharge outlet 32 side. The connecting shaft 42 extends toward the output shaft 64 side and is coupled with the journal 7. The connecting shaft 42 is shaped into a cylindrical form and has a diameter D1 that is generally equal to a diameter D2 of a shaft portion 43 of the male screw 4. The shaft portion 43 is a portion of the male screw 4 and has a minimum diameter in the male screw 4, and the blades are spirally formed along an outer peripheral surface of the shaft portion 43.

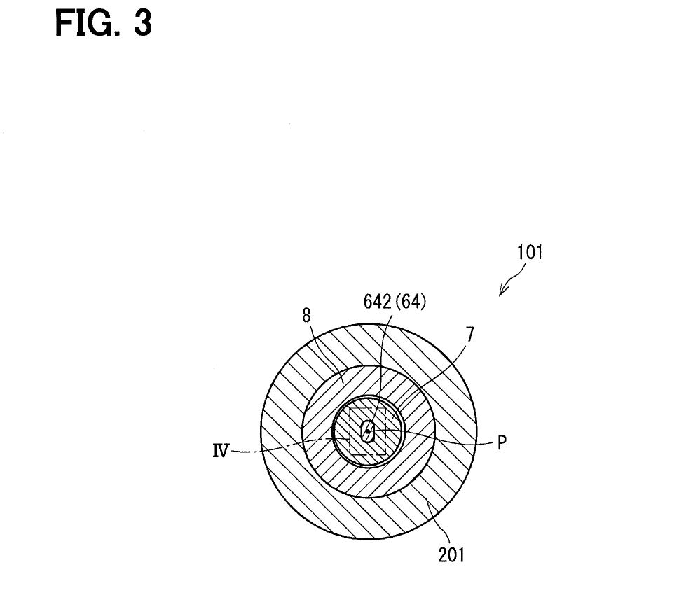

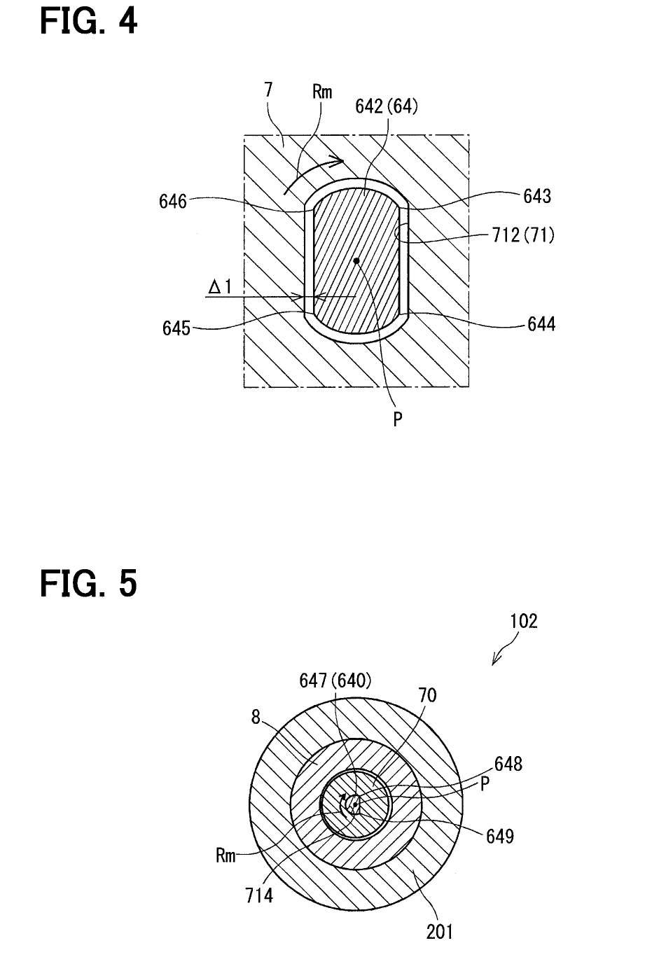

The output shaft 64 includes a main body portion 641, which is shaped into a cylindrical form, and a projecting portion 642, which is coaxial with the main body portion 641 and projects from the main body portion 641 toward the suction inlet 11 side. A radial cross-sectional area and an axial length of the projecting portion 642 are smaller than a radial cross-sectional area and an axial length of the main body portion 641. As shown in FIGS. 3 and 4, the projecting portion 642 is in a form that is produced by flatly cutting two diametrically opposed lateral sides of a cylindrical member in the axial direction of the cylindrical member, so that the projecting portion 642 has four corners 643, 644, 645, 646 in a radial cross-section of the projecting portion 642 taken in a radial direction of the projecting portion 642. The projecting portion 642 serves as an example of an engaging projection of the claims.

Now, the description will be made referring back to FIG. 2. The journal 7 has a hole 71, which extends through the journal 7 in the axial direction, and the output shaft 64 and the connecting shaft 42 are fitted into the hole 71. The hole 71 has a first hole section 711, a second hole section 712 and a third hole section 713, and these hole sections 711, 712, 713 are formed continuously one after another from the discharge outlet 32 side toward the suction inlet 11 side. A large diameter portion (the main body portion 641) of the output shaft 64 is fitted into the first hole section 711 by clearance fit. The projecting portion 642 at the tip of the output shaft 64 is fitted into the second hole section 712 by clearance fit. That is, as shown in FIG. 4, a clearance Δ1 is formed between the output shaft 64 and each of the hole sections 711, 712. The second hole section 712 serves as an example of an engaging recess of the claims. The connecting shaft 42 is press fitted into the third hole section 713. The journal 7 and the male screw 4 are coaxially and non-detachably integrated together.

At the time of assembling, the journal 7 and the male screw 4 are assembled to the case 201 such that the central axis of the journal 7 and the central axis of the male screw 4 coincide with the rotational axis P. At the time of rotating the output shaft 64, the two corners 643, 645 urge an inner wall of the second hole section 712, so that the output shaft 64 and the journal 7 are rotated integrally.

That is, although the journal 7 and the output shaft 64 are fitted together by the clearance fit, the configurations of the projecting portion 642 and the second hole section 712 prevent racing of the output shaft 64, and thereby the torque is transmitted from the output shaft 64 to the journal 7. The torque of the motor 6 is transmitted from the output shaft 64 to the male screw 4 through the journal 7.

Next, the overall assembling procedure of the screw pump 101 will be described. First of all, the bearing member 8 is fixed to the bearing receiving portion 23. Then, the male screw 4, which is integrated with the journal 7, is inserted into the case hole 21 from the discharge outlet 32 side. Thereafter, the female screw 5 is inserted into the case hole 21 from the suction inlet 11 side, and the respective screws 4, 5 are supported by the receiving plate 12, and the case hole 21 is closed with the lower cover 1. The motor 6 is integrally assembled in advance, and the output shaft 64 of the motor 6 is fitted to the journal 7 by the clearance fit, so that the motor 6 and the pump unit located on the case 201 side are assembled together.

### Advantages

(1) In the first embodiment, the journal 7 and the male screw 4 are coaxially and non-detachably integrated together, so that the central axis of the journal 7 and the central axis of the male screw 4 do not deviate relative to each other. For example, in a case where the journal 7 and the male screw 4 are integrated together by the clearance fit, there is a possibility of that the central axis of the journal 7 and the central axis of the male screw 4 deviate from each other due to influences of rattling at the clearance, and thereby the screw center may possibly deviate in the case hole 21. Even if the central axis of the screw 4 and the rotational axis P of the case are adjusted to coincide with each other at the time of assembling, it is difficult to maintain a constant clearance between the screw 4 and the case hole 21.

With respect to this point, according to the construction of the present embodiment, at the time of pumping the fluid, the central axis of the journal 7 and the central axis of the male screw 4 do not deviate relative to each other. Thus, the sliding loss and the wearing, which are caused by, for example, decentering of the screw relative to the case hole in the previously proposed screw pump, are reduced. In this way, the reliability of the sliding portions can be improved.

(2) In the first embodiment, the journal 7 and the male screw 4 are formed by the separate members, respectively, and the journal 7 and the male screw 4 are integrally assembled by the press fitting. In this way, the processing and the assembling of the respective members can be eased. Furthermore, the costs can be reduced.

(3) In the first embodiment, the journal 7 and the output shaft 64 are connected together by the clearance fit, so that the processing errors and the assembly errors can be absorbed. Furthermore, because of the clearance fit discussed above, the pump unit at the case 201 side and the motor 6 can be respectively assembled into the corresponding subassembly state and can be easily assembled together thereafter.

(4) In the first embodiment, the blade width W1 of the male screw 4 is smaller than the blade width W2 of the female screw. When the blade width of the screw is reduced, the seal length between the screw and the case 201 is reduced, so that the working fluid easily leaks from the high pressure side to the low pressure side in the case 201. In the present embodiment, on the male screw 4 side where the leakage is more likely to occur, the orientation of the male screw 4 is kept straight, and thereby the leakage of the working fluid can be efficiently reduced in comparison to the case where the orientation of the female screw 5 is adjusted.

(5) In the first embodiment, the diameter D1 of the connecting shaft 42 is generally equal to the diameter of the shaft portion 43 of the male screw 4. For example, when the diameter of the connecting shaft 42 is larger than the diameter of the shaft portion 43, the meshing between the blade of the male screw 4 and the blade of the female screw 5 is interrupted, thereby generating a wasteful space in the inside of the case 201. This will result in an increase in an axial length of the case 201, thereby possibly resulting in an increase in a size of the pump. In the present embodiment, the entire extent of the blade of the male screw 4, which is from one end to the other end of the blade, can be used to define a pressure chamber, so that the axial length can be minimized.

In addition, an incomplete blade portion is not formed in the blade, so that the screw configuration can be accurately formed from the one end to the other end of the blade.

(6) In the first embodiment, the male screw 4 can be installed at any location by adjusting an axial depth of the third hole section 713. The axial size adjustment is easy, and thereby the screw pump 101 can be constructed with a minimum required size.

(7) In the first embodiment, the journal 7 is made of the material that has the higher hardness in comparison to the material of the male screw 4, so that the reliability as the bearing can be improved, and thereby the performance of the screw pump can be maintained for a long period of time. Furthermore, the journal 7 and the male screw 4 are formed by the separate members, respectively, so that the processing is eased, and thereby the processing costs can be reduced.

(8) In the first embodiment, the projecting portion 642 of the output shaft 64 is in the form that is produced by flatly cutting the two diametrically opposed lateral sides of the cylindrical member in the axial direction of the cylindrical member, and the drive force is transmitted from the projecting portion 642 to the journal 7 through the two corners 643, 645 of the projecting portion 642 at the time of pumping the fluid. Thereby, the transmission of the drive force from the projecting portion 642 to the journal 7 is stabilized.

### Second Embodiment

Next, a screw pump 102 of a second embodiment of the present disclosure will be described with reference to FIG. 5. Portions, which are similar to those of the first embodiment, will be indicated by the same reference signs and will not be described redundantly for the sake of simplicity. The screw pump 102 of the second embodiment differs from the first embodiment with respect to the shape of the projecting portion 642 of the output shaft 64 and the shape of the second hole section 712 of the journal 7. The second embodiment differs from the first embodiment only with respect to the structures of these portions that transmit the torque, and the rest of the structure of the second embodiment is similar to that of the first embodiment. Therefore, the description about the overview and the overall structure of the screw pump will be omitted for the sake of simplicity.

As shown in FIG. 5, the projecting portion 647 is in a form that is produced by flatly cutting one lateral side of a cylindrical member in the axial direction of the cylindrical member, so that the projecting portion 642 is formed into a D-shape and has two corners 648, 649 in the radial cross-section of the projecting portion 647. A cross-sectional shape of the second hole section 714 of the journal 70 is a D-shape that corresponds to the projecting portion 647.

Similar to the first embodiment, the journal 70 and the output shaft 640 are fitted together by clearance fit. At the time of rotating the output shaft 640, the corner 648 urges the inner wall of the second hole section 714, so that the output shaft 640 and the journal 70 are integrally rotated. The configurations of the projecting portion 647 and the second hole section 714 discussed above prevent the racing of the output shaft 64, and thereby the torque is transmitted from the output shaft 64 to the journal 7.

The projecting portion 647 serves as an example of the engaging projection of the claims. The second hole section 714 serves as an example of the engaging recess of the claims.

Even in the second embodiment, the advantages (1) to (7) of the first embodiment can be achieved.

### Third Embodiment

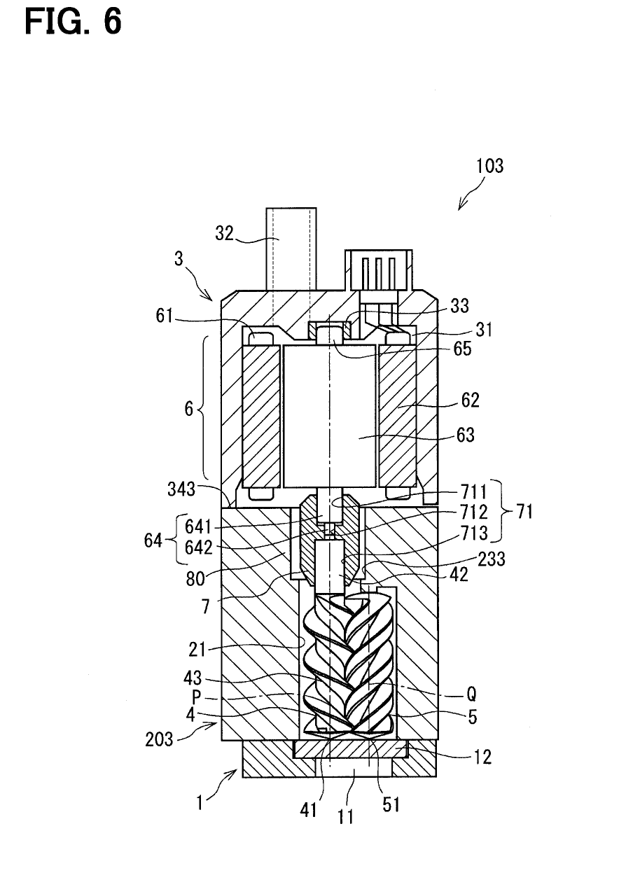

Next, a screw pump 103 of the third embodiment of the present disclosure will be described with reference to FIG. 6. The third embodiment differs from the first embodiment with respect to that the bearing member 8 is not provided.

In the third embodiment, a portion of the case 203 is used as the bearing portion 80. As shown in FIG. 6, a bearing receiving hole 233 is recessed at the end surface 343 of the case 203 located on the motor 6 side. The bearing receiving hole 233 and the case hole 21 are communicated with each other. The journal 7 is placed in the bearing receiving hole 233. The inner surface of the bearing receiving hole 233 is processed through a finish grinding process, so that the roughness of the inner surface of the bearing receiving hole 233 is small and an oil film is easily formed on the inner surface of the bearing receiving hole 233. In this way, a portion of the case 203 located around the bearing receiving hole 233 is formed as the bearing portion 80.

Even in the third embodiment, advantages, which are similar to those of the first embodiment, can be achieved.

### Fourth Embodiment

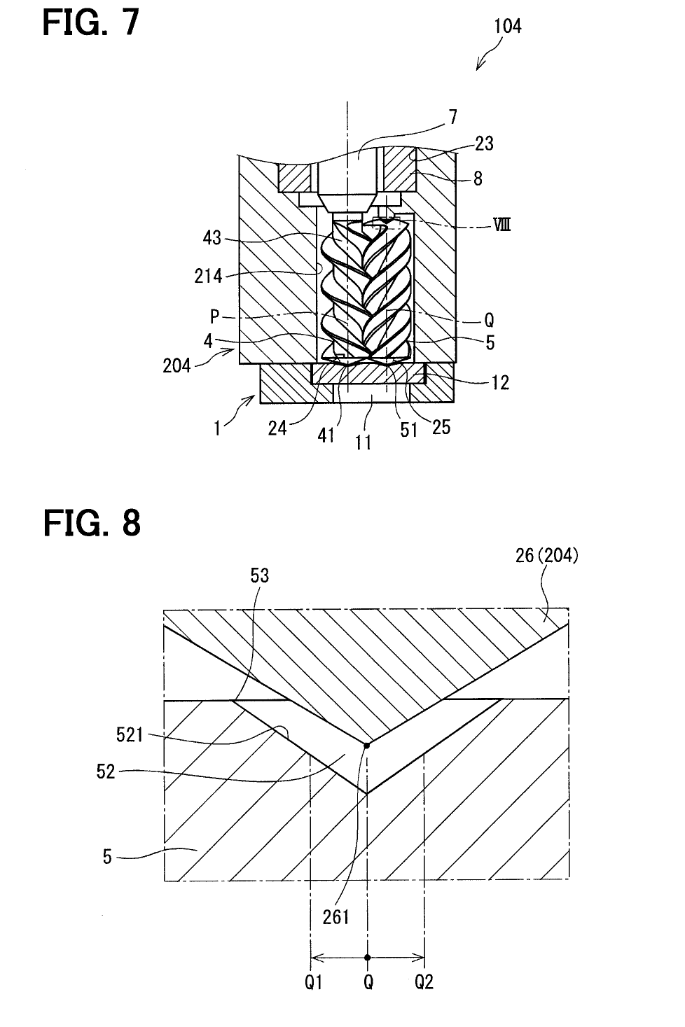

Next, a screw pump 104 of the fourth embodiment of the present disclosure will be described with reference to FIGS. 7 and 8. As shown in FIG. 7, a recess 24 is formed at a corresponding part of the receiving plate 12 that is located along an extension of the rotational axis P of the male screw 4. The tip apex 41 of the male screw 4 is received in the recess 24.

Similarly, a recess 25 is formed at a corresponding part of the receiving plate 12 that is located along an extension of the rotational axis Q of the female screw 5. The tip apex 51 of the female screw 5 is received in the recess 25. A bottom of each of the recesses 24, 25 is formed into a conical shape, and a minute gap is formed between each tip apex 41, 51 and the corresponding recess 24, 25.

As shown in FIG. 8, a screw-side recess 52 is formed along an extension of the rotational axis Q of the female screw 5 at a corresponding part of a tip of the female screw 5 located on the discharge outlet 32 side. A bottom 521 of the screw-side recess 52 is formed into a conical shape. Furthermore, a projection 26 is formed at a corresponding part of an inner wall of the case hole 214, which is opposed to the screw-side recess 52. The projection 26 is formed into a conical shape, and a tip 261 of the projection 26 is received in the screw-side recess 52.

At the time of pumping the fluid, when the male screw 4 drives the female screw 5 to rotate the same, a force, which is exerted in a direction from the high pressure side to the low pressure side, is applied to the male screw 4 in a direction of meshing between the male screw 4 and the female screw 5, and a force, which is exerted in a direction from the low pressure side to the high pressure side, is applied to the female screw 5 in the direction of meshing between the male screw 4 and the female screw 5. Therefore, the movement of the female screw 5 toward the high pressure side is limited by the provision of the projection 26 to the case 204, and thereby the female screw 5 can be held within a predetermined range.

Specifically, when the rotational axis Q of the female screw 5 is decentered, the decentering of the rotational axis Q of the female screw 5 is limited at a corresponding one of positions Q1, Q2, at each of which an edge 53 of the recess 52 is configured to contact a sloped surface of the projection 26. With respect to the tip apex 41, 51 of each of the screws 4, 5, decentering of the rotational axis of each of the screws 4, 5 can be limited by the same principle. Furthermore, at the contacting portion between the tip of the female screw 5 and the case 204, a contact surface area is reduced through the combination of the screw-side recess 52 and the projection 26, each of which is formed into the corresponding conical shape, so that the sliding loss can be reduced.

### Fifth Embodiment

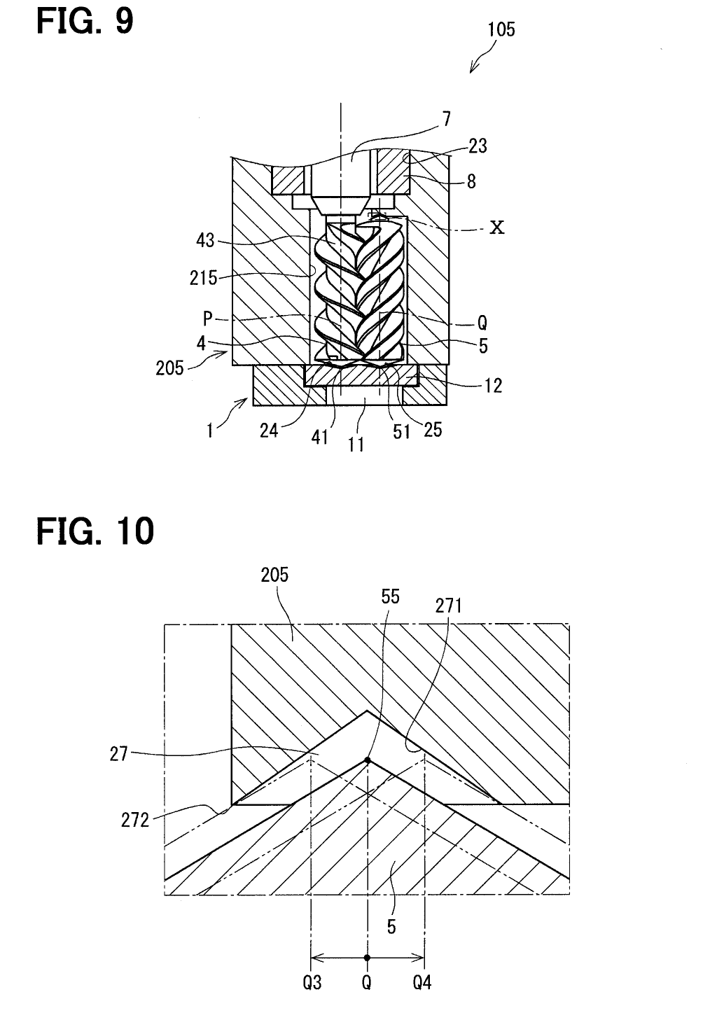

Next, a screw pump 105 of a fifth embodiment of the present disclosure will be described with reference to FIGS. 9 and 10. The fifth embodiment differs from the fourth embodiment with respect to the configuration of the tip of the female screw 5 located on the discharge outlet 32 side along the extension of the rotational axis Q of the female screw 5. The fifth embodiment is similar to the fourth embodiment with respect to the formation of the recesses 24, 25 at the corresponding locations, which are respectively opposed to the tip apexes 41, 51 of the screws 4, 5 located on the suction inlet 11 side.

As shown in FIGS. 9 and 10, the tip apex 55 of the female screw 5, which is located along the extension of the rotational axis Q of the female screw 5, is configured in a form of a conical projection. Furthermore, a recess 27 is formed at a part of the inner wall of the case hole 215, which is opposed to the tip apex 55, in the case 205. A bottom 271 of the recess 27 is formed into a conical shape, and the tip apex 55 is received in the recess 27.

When the rotational axis Q of the female screw 5 is decentered, the decentering of the rotational axis Q of the female screw 5 is limited at a corresponding one of positions Q3, Q4, at each of which an opening edge 272 of the recess 27 is configured to contact a sloped surface of the tip of the female screw 5.

### Sixth Embodiment

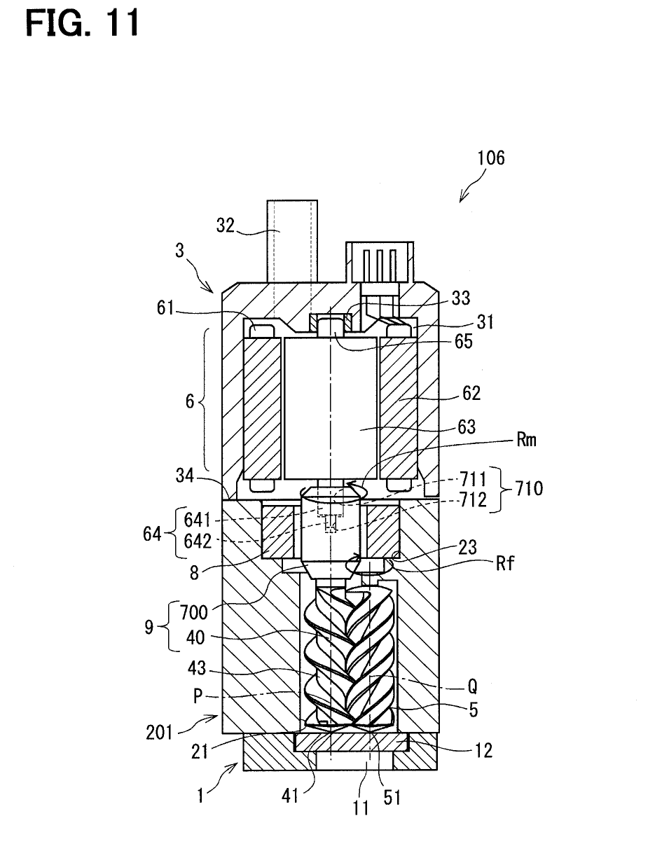

Next, a screw pump 106 according to a sixth embodiment of the present disclosure will be described with reference to FIG. 11. As shown in FIG. 11, the screw pump 106 of the sixth embodiment differs from the first embodiment with respect to that the journal 7 and the male screw 4 are formed integrally in one piece by a common member. As shown in FIG. 11, a screw member 9, in which a male screw portion (male screw) 40 and a journal portion 700 are formed integrally in one piece, is formed by, for example, a cutting process. A hole 710 is formed in the journal portion 700. The hole 710 includes the first hole section 711 and the second hole section 712. The hole sections 711, 712 are formed continuously one after another in the axial direction from the discharge outlet 32 side to the suction inlet 11 side.

Even in the sixth embodiment, the advantages (1) to (6) and (8) of the first embodiment can be achieved.

### Other Embodiments

In the above respective embodiments, although the diameter D1 of the connecting shaft 42 is set to be the same as the diameter D2 of the shaft portion 43, the diameter of the connecting shaft 42 may be smaller than the diameter of the shaft portion 43. Furthermore, if there is no restriction with respect to the size of the screw pump, the diameter of the connecting shaft 42 may be increased from the diameter of the shaft portion 43.

In the above respective embodiments, for example, a recess, which has a radial cross section that is configured into a D-shape, may be formed at the output shaft 64, and a projection, which is configured to fit with the recess of the output shaft 64 by clearance fit, may be formed at the journal 7. As long as the rotational drive force can be transmitted through the coupling between the output shaft 64 and the journal 7, the combination of the recess and the projection may be reversed from the above-described one.

Furthermore, the output shaft 64 may have only the main body portion 641, which is configured into the cylindrical form. In this case, the output shaft 64 and the journal 7 may be coupled together by, for example, a pin that is inserted in the output shaft 64 and the journal 7 in the radial direction, so that the racing of the output shaft 64 can be prevented.

In the above embodiments, the shape of the radial cross-section of the projecting portion 642, 647 of the output shaft 64 may be changed to a triangular shape or another polygonal shape. The fitting between the projecting portion and the second hole section of the journal 7 may be achieved by any combination of shapes that enables transmission of the drive force from the output shaft 64 to the journal 7 even in the state of the clearance fit.

In the first to fifth embodiments, although the male screw 4 and the journal 7 are integrated together by the press fitting, the male screw 4 and the journal 7 may be integrated together by heat-shrink fitting. It is only required that the male screw 4 and the journal 7 are coaxially and non-detachably integrated together.

In the first to fifth embodiments, although the hole 71 extends through the journal 7 in the axial direction, the hole 71 may be formed without extending through the journal 7. For example, the portion, into which the output shaft 64 is inserted, may be formed separately from the portion, into which the connecting shaft 42 is inserted.

In the fourth and fifth embodiments, although the bottoms of the recesses 24, 25, 27, 52 are respectively configured into the conical shape, it is only required that the opposing tip apexes 41, 51, 55 and the opposing tip 261 are respectively receivable into the corresponding recesses 24, 25, 27, 52, and thereby the recesses 24, 25, 27, 52 may be respectively shaped into another shape, such as a bottomed hole having a flat bottom or a recess having a semispherical bottom.

The screw pump of each of the above embodiments includes a single driving-side screw and a single driven-side screw. In another embodiment, the screw pump may have a structure of that a plurality of driven-side screws are arranged around the single driving-side screw.

Contrary to each of the above-described embodiments, the female screw may be configured as a driving-side screw, and the male screw may be configured as a driven-side screw.

Besides the electric motor 6, the drive device may be a rotational actuator that uses a hydraulic pressure or an air pressure as a drive source. Furthermore, the drive device may be placed at an outside of the upper cover.

The other structure(s) of the screw pump, which is other than the joint between the journal 7 and the male screw 4 and the joint between the journal 7 and the output shaft 64 that are the characteristic features of the present disclosure and are discussed in detail in the respective embodiments, may be modified in the above embodiments in terms of, for example, the shapes, the locations, the numbers of the components.

The fluid, for which the screw pump of the present disclosure is used, is not necessarily limited to the fuel, and the screw pump of the present disclosure may be used for another type of fluid, such liquid, which is other than the fuel, or gas (e.g., air).

The present disclosure should not be necessarily limited to any of the above embodiments and may be implemented in various other forms within the scope of the present disclosure.

1. A screw pump that pumps fluid from a suction inlet at a low pressure side to a discharge outlet at a high pressure side when a driving-side screw, which is one of a male screw or a female screw, and at least one driven-side screw, which is another one of the male screw or the female screw, are rotated while the driving-side screw and the at least one driven-side screw are meshed with each other, the screw pump comprising:
the driving-side screw;
the at least one driven-side screw;
a drive device that includes an output shaft that transmits a torque to the driving-side screw, wherein the drive device is operable to rotate the driving-side screw through the output shaft;
a journal portion that is rotatably placed between the output shaft of the drive device and the driving-side screw;
a bearing portion that rotatably supports the journal portion; and
a case that includes a screw receiving hole, which receives the driving-side screw and the at least one driven-side screw, wherein:
the journal portion and the driving-side screw are coaxially and non-detachably integrated together; and
the output shaft and the journal portion are fitted together by clearance fit that enables transmission of the torque between the output shaft and the journal portion.

2. The screw pump according to claim 1, wherein the journal portion and the driving-side screw are formed by a common member.

3. The screw pump according to claim 1, wherein the journal portion and the driving-side screw are formed by separate members, respectively, and are tightly fitted together.

4. The screw pump according to claim 1, further comprising:
an engaging projection that is formed at one of the journal portion and the output shaft and has corners in a cross section of the engaging projection that is taken in a radial direction of the output shaft; and
an engaging recess that is formed at another one of the journal portion and the output shaft and receives the engaging projection.

5. The screw pump according to claim 3, further comprising a connecting shaft that is formed integrally with the driving-side screw in one piece, wherein the connecting shaft extends toward the output shaft and is coupled with the journal portion, and a diameter of the connecting shaft is equal to or smaller than a diameter of a shaft portion of the driving-side screw.

6. The screw pump according to claim 1, wherein:
a projection, which projects toward the suction inlet along an extension of a rotational axis of the at least one driven-side screw, is formed at the screw receiving hole; and
the at least one driven-side screw has a screw-side recess that is formed along the extension of the rotational axis of the at least one driven-side screw and receives a tip of the projection.

7. The screw pump according to claim 1, wherein the screw receiving hole has a recess that is formed along an extension of a rotational axis of the at least one driven-side screw and receives a tip apex of the at least one driven-side screw, which is located on the discharge outlet side.

8. The screw pump according to claim 1, wherein the bearing portion and the case are formed by a common member.
